(19) United States
(12) Patent Application Publication
(10) Pub. No.: US 2024/0169705 A1
(43) Pub. Date: May 23, 2024

(54) DATA CREATION APPARATUS, STORAGE DEVICE, DATA PROCESSING SYSTEM, DATA CREATION METHOD, PROGRAM, AND IMAGING APPARATUS

(71) Applicant: FUJIFILM Corporation, Tokyo (JP)

(72) Inventors: Toshiki KOBAYASHI, Saitama-shi (JP); Yuya NISHIO, Saitama-shi (JP); Shoki KASAHARA, Saitama-shi (JP); Kenkichi HAYASHI, Saitama-shi (JP)

(73) Assignee: FUJIFILM Corporation, Tokyo (JP)

(21) Appl. No.: 18/420,705

(22) Filed: Jan. 23, 2024

Related U.S. Application Data
(63) Continuation of application No. PCT/JP2022/023213, filed on Jun. 9, 2022.

(30) Foreign Application Priority Data
Jul. 30, 2021 (JP) 2021-125785

(51) Int. Cl. G06V 10/774; G06V 10/771; G06V 10/778

(52) U.S. Cl. CPC G06V 10/774; G06V 10/771; G06V 10/7788

(57) ABSTRACT

Image data to be used for creating training data is appropriately selected from a plurality of pieces of image data in each of which an image in which a plurality of subjects are captured is recorded.

One embodiment of the present invention is a data creation apparatus that creates training data used in machine learning from image data in which accessory information is recorded in an image in which a plurality of subjects are captured, the data creation apparatus being configured to execute setting processing of setting any setting condition related to identification information and to image quality information with respect to a plurality of pieces of image data in which the accessory information including a plurality of pieces of the identification information assigned in association with the plurality of subjects and a plurality of pieces of the image quality information assigned in association with the plurality of subjects is recorded, and creation processing of creating the training data based on selection image data in which the identification information and the image quality information satisfying the setting condition are recorded.

### CROSS-REFERENCE TO RELATED APPLICATIONS

This application is a Continuation of PCT International Application No. PCT/JP2022/023213 filed on Jun. 9, 2022, which claims priority under 35 U.S.C. § 119(a) to Japanese Patent Application No. 2021-125785 filed on Jul. 30, 2021. The above applications are hereby expressly incorporated by reference, in their entirety, into the present application.

### BACKGROUND OF THE INVENTION

### 1. Field of the Invention

One embodiment of the present invention relates to a data creation apparatus, a data creation method, and a program for creating training data for machine learning. In addition, one embodiment of the present invention relates to a storage device that stores image data for creating training data, a data processing system that executes learning processing using training data, and an imaging apparatus that generates image data.

### 2. Description of the Related Art

In the case of performing machine learning using image data as training data, it is important to appropriately select (annotate) the image data to be used as the training data. However, since selecting the image data to be used as the training data from an enormous amount of image data requires significant effort and processing time, a cost of creating the training data is increased. Thus, in recent years, a technology for selecting the image data to be used for creating the training data in accordance with a predetermined selection reference has been developed (for example, refer to JP2014-137284A).

As a method of selecting the image data to be used for creating the training data, for example, a method of obtaining a feature amount of an image recorded in the image data and determining whether or not the image data can be used as the training data based on the feature amount is considered.

### SUMMARY OF THE INVENTION

A plurality of subjects may be captured in the image. In this case, it is required to appropriately determine whether or not the image data can be used as the training data based on a location in which each subject is captured.

An object of one embodiment of the present invention is to appropriately select image data to be used for creating training data from a plurality of pieces of image data in each of which an image in which a plurality of subjects are captured is recorded.

In order to achieve the above object, one embodiment of the present invention is a data creation apparatus that creates training data used in machine learning from image data in which accessory information is recorded in an image in which a plurality of subjects are captured, the data creation apparatus being configured to execute setting processing of setting any setting condition related to identification information and to image quality information with respect to a plurality of pieces of image data in which the accessory information including a plurality of pieces of the identification information assigned in association with the plurality of subjects and a plurality of pieces of the image quality information assigned in association with the plurality of subjects is recorded, and creation processing of creating the training data based on selection image data in which the identification information and the image quality information satisfying the setting condition are recorded.

In addition, the image quality information may be information related to any of resolution of the subject in the image indicated by the image data, brightness of the subject, and noise occurring at a position of the subject.

In addition, the image quality information may be resolution information related to the resolution, and the resolution information may be information determined in accordance with blurriness and shake levels of the subject in the image indicated by the image data.

In addition, the image quality information may be resolution information related to the resolution, and the resolution information may be resolution level information related to a resolution level of the subject in the image indicated by the image data. In this case, the setting condition may be a condition including an upper limit and a lower limit of the resolution level of the subject.

In addition, the image quality information may be information related to the brightness of the subject or information related to the noise occurring at the position of the subject. Here, the information related to the brightness may be a brightness value corresponding to the subject. In addition, the information related to the noise may be an S/N value corresponding to the subject. In this case, the setting condition may be a condition including an upper limit and a lower limit of the brightness value or an upper limit and a lower limit of the S/N value corresponding to the subject.

In addition, the accessory information may further include a plurality of pieces of positional information assigned in association with the plurality of subjects. The positional information may be information indicating a position of the subject in the image indicated by the image data.

In addition, the data creation apparatus may be configured to further execute display processing of displaying an image indicated by the selection image data or a sample image having image quality satisfying the setting condition before executing the creation processing.

In the above configuration, it is suitable that two or more pieces of the selection image data are selected from the plurality of pieces of image data, and in the display processing, an image of a part of the selection image data among the two or more pieces of the selection image data is displayed.

In addition, it is more suitable that in the display processing, images of the selected pieces of the selection image data are displayed based on a priority level set for each selection image data.

In addition, the data creation apparatus may be configured to further execute determination processing of determining a purpose of the machine learning in accordance with designation from a user, in which in the setting processing, the setting condition corresponding to the purpose is set.

In addition, the data creation apparatus may be configured to further execute determination processing of determining a purpose of the machine learning in accordance with designation from a user, in which in the setting processing, the setting condition corresponding to the purpose is suggested to the user before setting the setting condition.

In addition, the data creation apparatus may be configured to further execute suggestion processing of suggesting an additional condition different from the setting condition to a user. In this case, the additional condition may be a condition set with respect to the accessory information, additional image data may be selected under the additional condition from non-selection image data of which the identification information and the image quality information do not satisfy the setting condition. In a case where the additional image data is selected, the training data may be created in the creation processing based on the selection image data and on the additional image data.

In addition, a storage device according to one embodiment of the present invention is a storage device that stores the plurality of pieces of image data to be used for creating the training data via the data creation apparatus.

In addition, a data processing system according to one embodiment of the present invention is a data processing system comprising a data creation apparatus that creates training data from image data in which accessory information is recorded in an image in which a plurality of subjects are captured, and a learning apparatus that performs machine learning using the training data, the data processing system being configured to execute setting processing of setting any setting condition related to identification information and to image quality information with respect to a plurality of pieces of image data in which the accessory information including a plurality of pieces of the identification information assigned in association with the plurality of subjects and a plurality of pieces of the image quality information assigned in association with the plurality of subjects is recorded, creation processing of creating the training data based on selection image data in which the identification information and the image quality information satisfying the setting condition are recorded, and learning processing of performing the machine learning using the training data.

In addition, a data creation method according to one embodiment of the present invention is a data creation method of creating training data used in machine learning from image data in which accessory information is recorded in an image in which a plurality of subjects are captured, the data creation method comprising a setting step of setting any setting condition related to identification information and to image quality information with respect to a plurality of pieces of image data in which the accessory information including a plurality of pieces of the identification information assigned in association with the plurality of subjects and a plurality of pieces of the image quality information assigned in association with the plurality of subjects is recorded, and a creation step of creating the training data based on selection image data in which the identification information and the image quality information satisfying the setting condition are recorded.

In addition, a program according to one embodiment of the present invention is a program causing a computer to function as the data creation apparatus, the program causing the computer to execute each of the setting processing and the creation processing.

In addition, an imaging apparatus according to one embodiment of the present invention is an imaging apparatus that executes imaging processing of capturing an image in which a plurality of subjects are captured, and generation processing of generating image data by recording accessory information in the image, in which the accessory information includes a plurality of pieces of identification information assigned in association with the plurality of subjects and a plurality of pieces of image quality information assigned in association with the plurality of subjects.

In the above imaging apparatus, the accessory information may be information for selecting selection image data to be used for creating training data for machine learning.

### BRIEF DESCRIPTION OF THE DRAWINGS

FIG. 1 is a configuration diagram of a data processing system including a data creation apparatus according to one embodiment of the present invention.

FIG. 2 is a flowchart illustrating a basic operation of the data processing system according to one embodiment of the present invention.

FIG. 3 is a descriptive diagram for accessory information stored in image data and is a diagram illustrating a storage region of the image data.

FIG. 4 is a diagram illustrating a case where a data file of the accessory information is stored in association with the image data.

FIG. 5A is a descriptive diagram for each information included in the accessory information.

FIG. 5B is a descriptive diagram for image quality information.

FIG. 5C is a descriptive diagram for characteristic information.

FIG. 6 is a diagram illustrating a data creation flow according to a first embodiment of the present invention.

FIG. 7 is a diagram illustrating an example of an input screen for searching for image data.

FIG. 8 is a diagram illustrating an example of an additional condition.

FIG. 9 is a diagram illustrating an example of a display screen of the additional condition.

FIG. 10 is a diagram illustrating a data creation flow according to a second embodiment of the present invention.

FIG. 11 is a diagram illustrating another example of the input screen for searching for image data.

FIG. 12 is a diagram illustrating an example of a display screen of an image recorded in selection image data.

### DESCRIPTION OF THE PREFERRED EMBODIMENTS

One suitable embodiment (hereinafter, the present embodiment) of the present invention will be described in detail with reference to the accompanying drawings. It should be noted that the embodiment described below is merely an example for facilitating understanding of the present invention and does not limit the present invention. That is, changes or improvements may be made from the embodiment described below without departing from the gist of the present invention. In addition, the present invention includes equivalents thereof.

In addition, in the present specification, a concept of an “apparatus” is assumed to include not only a single apparatus that exhibits a specific function but also a plurality of apparatuses that are distributed independently of each other and that cooperate to exhibit a specific function.

In addition, in the present specification, a “person” means an agent that performs a specific action, and its concept includes an individual, a group, a corporation such as a company, and an organization and may further include a computer and a device constituting artificial intelligence (AI). The artificial intelligence implements intellectual functions such as reasoning, prediction, and determination using hardware resources and software resources. The artificial intelligence may use any algorithm such as, for example, an expert system, case-based reasoning (CBR), a Bayesian network, or a subsumption architecture.

<<Data Creation Apparatus According to Present Embodiment>>

A data creation apparatus (hereinafter, a data creation apparatus 10) according to the present embodiment is an apparatus that creates training data used in machine learning from image data. Specifically, the data creation apparatus 10 is an apparatus for annotation support having a function of selecting the image data for creating training data from multiple pieces of image data.

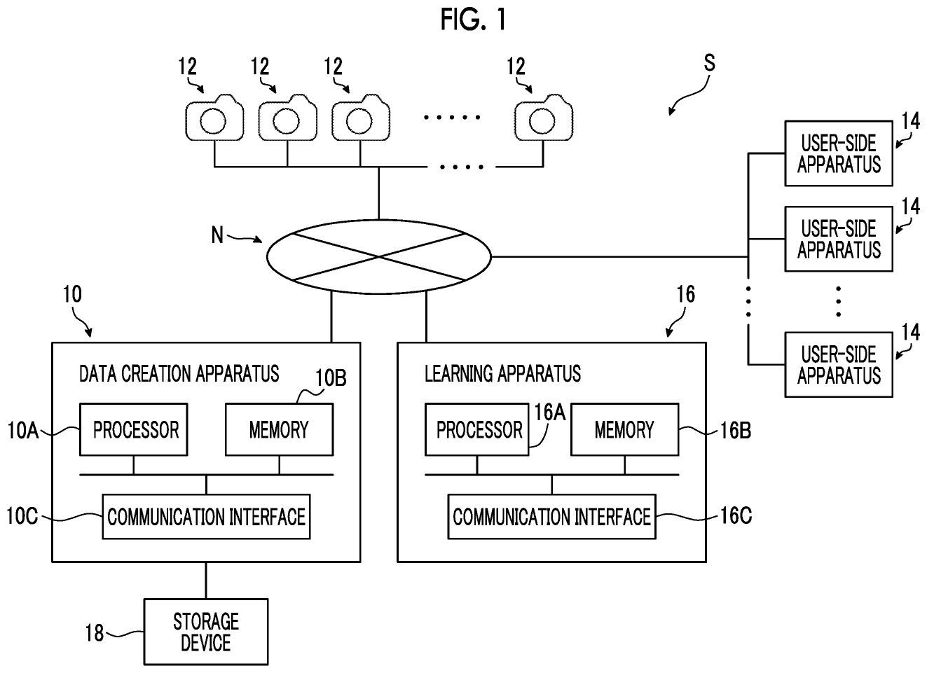

As illustrated in FIG. 1, the data creation apparatus 10 constitutes a data processing system S together with an imaging apparatus 12, a user-side apparatus 14, and a learning apparatus 16. The data processing system S performs the machine learning in accordance with a request of a user and provides an inference model obtained as a result of learning to the user. The user can identify or predict a type, a state, and the like of a subject of an image acquired by the user using the inference model.

The imaging apparatus 12 is composed of a well-known digital camera, a communication terminal incorporating a camera, or the like. The imaging apparatus 12 is operated by its owner and captures an image in which a subject is captured under an imaging condition set by an operation of the owner or by a function of the imaging apparatus 12. That is, a processor (imaging apparatus-side processor) of the imaging apparatus 12 executes imaging processing by receiving an imaging operation of the owner and captures the image.

In addition, the imaging apparatus-side processor executes generation processing of generating the image data by recording accessory information in the captured image. The accessory information is tag information related to the image and to use and the like of the image and includes tag information of a so-called exchangeable image file format (Exit) and the like. The accessory information will be described in detail in a later section.

The data creation apparatus 10 creates the training data used in the machine learning using the image data in which the accessory information is recorded. That is, the data creation apparatus 10 is configured to execute the series of data processing for creating the training data for the machine learning. The training data may be the image data itself or may be obtained by performing predetermined processing with respect to the image data, such as cutting out (trimming) a specific subject in the image indicated by the image data.

In a case where the imaging apparatus 12 comprises a communication function, the image data is transmitted from the imaging apparatus 12 toward the data creation apparatus 10 via a network N. However, the present invention is not limited thereto. An apparatus such as a personal computer (PC) may acquire the image data from the imaging apparatus 12, and the image data may be transmitted from the apparatus toward the data creation apparatus 10.

The user-side apparatus 14 is composed of, for example, a PC or a communication terminal owned by the user. The user-side apparatus 14 receives an operation of the user and transmits data corresponding to the operation toward the data creation apparatus 10, the learning apparatus 16, or the like. In a case where the imaging apparatus 12 owned by the user comprises a communication function and comprises a function that can display information based on received data, the imaging apparatus 12 may be used as the user-side apparatus 14.

In addition, the user-side apparatus 14 comprises a display, not illustrated, and displays information corresponding to data received from the data creation apparatus 10 or from the learning apparatus 16 on the display. For example, in a case where the user uses the inference model obtained by performing the machine learning via the learning apparatus 16, the user-side apparatus 14 displays an inference result and the like obtained from the inference model on the display.

In a case where a request to perform the machine learning is received from the user, the learning apparatus 16 performs the machine learning using the training data created by the data creation apparatus 10. The machine learning is an analysis technology or the like related to a technology and the artificial intelligence for learning regularity and a determination reference from data and predicting and determining an unknown event based on the regularity and on the determination reference. The inference model constructed by the machine learning is any mathematical model. For example, a neural network, a convolutional neural network, a recurrent neural network, attention, a transformer, a generative adversarial network, a deep learning neural network, a Boltzmann machine, matrix factorization, a factorization machine, an M-way factorization machine, a field-aware factorization machine, a field-aware neural factorization machine, a support vector machine, a Bayesian network, a decision tree, or a random forest can be used.

The data creation apparatus 10 and the learning apparatus 16 are connected to be capable of communicating with each other and exchange data between apparatuses. The data creation apparatus 10 and the learning apparatus 16 may be independent of each other as separate apparatuses or may be integrated as a single apparatus.

The data creation apparatus 10 and the learning apparatus 16 are implemented by a processor and a program executable by the processor and are composed of, for example, a general-purpose computer, specifically, a server computer. As illustrated in FIG. 1, the computer constituting the data creation apparatus 10 and the computer constituting the learning apparatus 16 comprise processors 10A and 16A, memories 10B and 16B, communication interfaces 10C and 16C, and the like, respectively.

The processors 10A and 16A are composed of, for example, a central processing unit (CPU), a graphics processing unit (GPU), a digital signal processor (DSP), or a tensor processing unit (TPU). The memories 10B and 16B are composed of a semiconductor memory such as a read only memory (ROM) and a random access memory (RAM).

A program for creating the training data (hereinafter, a training data creation program) is installed on the computer constituting the data creation apparatus 10. The computer comprising the processor 10A functions as the data creation apparatus 10 by reading out and executing the training data creation program via the processor 10A. That is, the training data creation program is a program causing the computer to execute each processing for creating the training data (specifically, each processing and the like in a data creation flow, described later).

Meanwhile, a program for executing learning (hereinafter, a learning execution program) is installed on the computer constituting the learning apparatus 16. The computer comprising the processor 16A functions as the learning apparatus 16 by reading out and executing the learning execution program via the processor 16A. That is, the learning execution program is a program causing the computer to execute processing related to the machine learning (specifically, learning processing, described later).

Each of the training data creation program and the learning execution program may be acquired by reading the programs from a computer readable recording medium. Alternatively, each of the two programs may be acquired by receiving (downloading) the programs through the Internet, an intranet, or the like.

The data processing system S is provided with a storage device 18 that stores a plurality of pieces of image data to be used for creating the training data. In the storage device 18, the plurality of pieces of image data including the image data transmitted from the imaging apparatus 12 or the like are accumulated as a database. The image data accumulated in the storage device 18 may include image data acquired by reading and digitizing a printed (developed) analog photo via a scanner or the like.

The storage device 18 may be a device mounted in the data creation apparatus 10 or in the learning apparatus 16 or may be provided on a third computer (for example, an external server) side that can communicate with the data creation apparatus 10 or with the learning apparatus 16.

[Basic Operation of System]

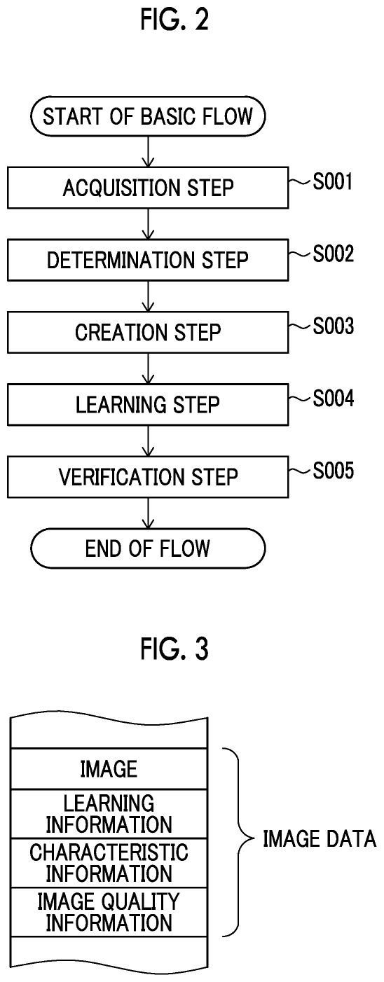

Next, a basic operation of the data processing system S will be described with reference to FIG. 2. In a data processing flow (hereinafter, a basic flow) of the data processing system S, acquisition step S001, determination step S002, creation step S003, learning step S004, and verification step S005 are performed in this order.

Acquisition step S001, for example, is performed in a stage before creating the training data. In the present step, acquisition processing is executed by the processor 10A of the data creation apparatus 10. In the acquisition processing, the processor 10A acquires the plurality of pieces of image data in which the accessory information is recorded. Specifically, the processor 10A obtains (receives) the plurality of pieces of image data from the imaging apparatus 12, the user-side apparatus 14, or the like. The acquired image data is stored in the storage device 18 to be accumulated as a database.

A source from which the image data is acquired is not particularly limited and may be an apparatus other than the imaging apparatus 12 and the user-side apparatus 14, for example, an external server (not illustrated) connected to the network N.

Determination step S002 is started in a case where the processor 10A of the data creation apparatus 10 receives a request to perform the machine learning from the user as a trigger. In the present step, determination processing is executed by the processor 10A. In executing the determination processing, the user who has made the request to perform the machine learning designates a learning purpose. Specifically, the user inputs text information representing the learning purpose or selects a desired candidate from candidates of the learning purpose prepared in advance. The processor 10A determines the learning purpose in accordance with designation of the purpose received from the user.

Here, the “learning purpose” is a theme or a subject matter of learning and corresponds to, for example, “identification or estimation of the type or the state of the subject in the image”. Hereinafter, the learning purpose determined in determination step S002 will be referred to as a “determination purpose” for convenience.

In creation step S003, the processor 10A identifies the image data for creating the training data from the plurality of pieces of image data stored in the storage device 18 and creates the training data using the selected image data. Specifically, the user who has made the request to perform the machine learning inputs information required for searching for (extracting) the image data for creating the training data. Here, the input information includes information corresponding to the determination purpose. For example, the type, the state, or the like of the subject that can be identified using the machine learning is included.

The processor 10A sets a condition (hereinafter, a setting condition) based on the input information of the user and selects image data satisfying the setting condition from the plurality of pieces of image data stored in the storage device 18 as selection image data. The processor 10A creates the training data using the selection image data.

The training data is generally divided into correct answer data and incorrect answer data. The correct answer data is training data indicating an image in which a subject (hereinafter, a correct answer subject) that coincides with the determination purpose is captured. The incorrect answer data is training data indicating an image in which a subject different from the correct answer subject is captured. To describe using a specific example, in a case where the determination purpose is “determination as to whether or not the subject in the image is an orange fruit”, training data indicating an image in which an orange fruit is captured is used as the correct answer data. Meanwhile, training data indicating an image in which a persimmon fruit or a ball of an orange color is captured is used as the incorrect answer data.

In the present embodiment, the training data corresponding to the incorrect answer data is created based on additional image data, described later. For example, the training data is created based on image data of an image in which a subject similar to the correct answer subject is captured.

In learning step S004, the learning processing is executed by the processor 16A of the learning apparatus 16. In the learning processing, the processor 16A performs the machine learning in accordance with the determination purpose using the training data created in creation step S003. While the training data of the correct answer data is mainly used in the machine learning, the incorrect answer data may be used together with the correct answer data for the aim of improving accuracy of the machine learning.

In verification step S005, the processor 16A performs a verification test related to the inference model using a part of the training data in order to evaluate validity (accuracy) of the inference model obtained as a result of the machine learning.

In the basic flow described so far, determination step S002, creation step S003, learning step S004, and verification step S005 are repeatedly performed each time the request to perform the machine learning is newly received from the user.

[Accessory Information]

The accessory information, that is, a tag, is stored in each of the plurality of pieces of image data accumulated in the storage device 18. The accessory information will be described with reference to FIG. 3 to FIG. 5C. FIG. 3 illustrates a region in which one piece of image data is stored among storage regions of the storage device 18.

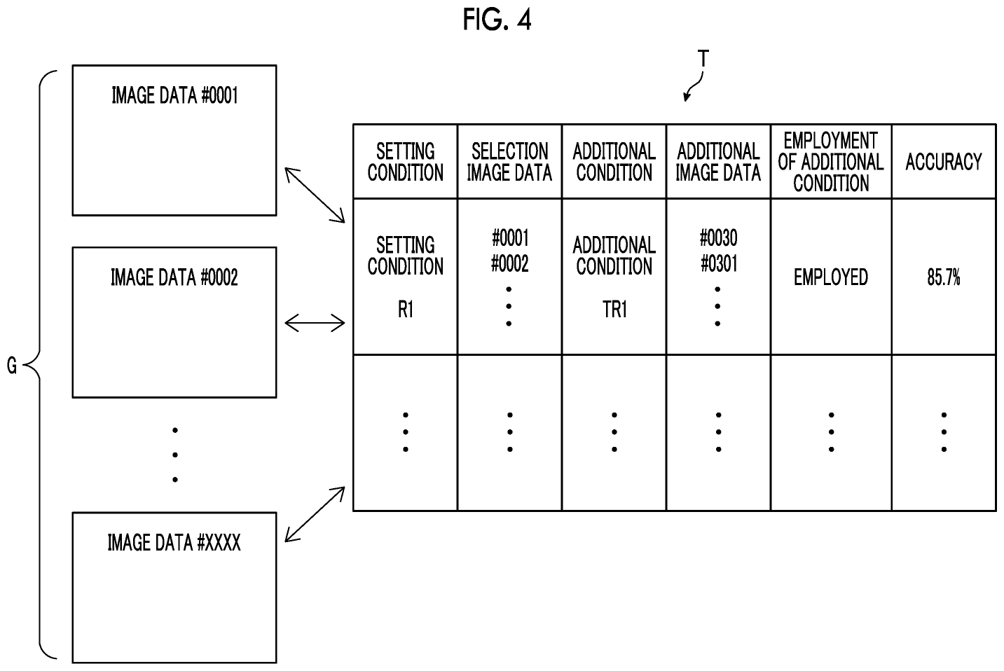

In the present embodiment, recording of the accessory information includes direct recording and indirect recording. Direct recording means directly recording the accessory information in the image data. Indirect recording means recording the accessory information in association with the image data. Specifically, as illustrated in FIG. 4, the accessory information may be recorded in a data file T separate from the image data. In this case, each ID information of an image data group G selected under a certain setting condition is associated with the data file T, and the data file T can be read out using the ID information of each image data as a key.

The accessory information is information for selecting the selection image data from the plurality of pieces of image data accumulated in the storage device 18 and is referred to by the data creation apparatus 10 during execution of the selection processing. As illustrated in FIG. 3, the accessory information includes characteristic information, image quality information, and learning information. The accessory information stored in the image data does not necessarily include all of the characteristic information, the image quality information, and the learning information and may include at least one of the characteristic information or the image quality information and include the learning information.

(Learning Information)

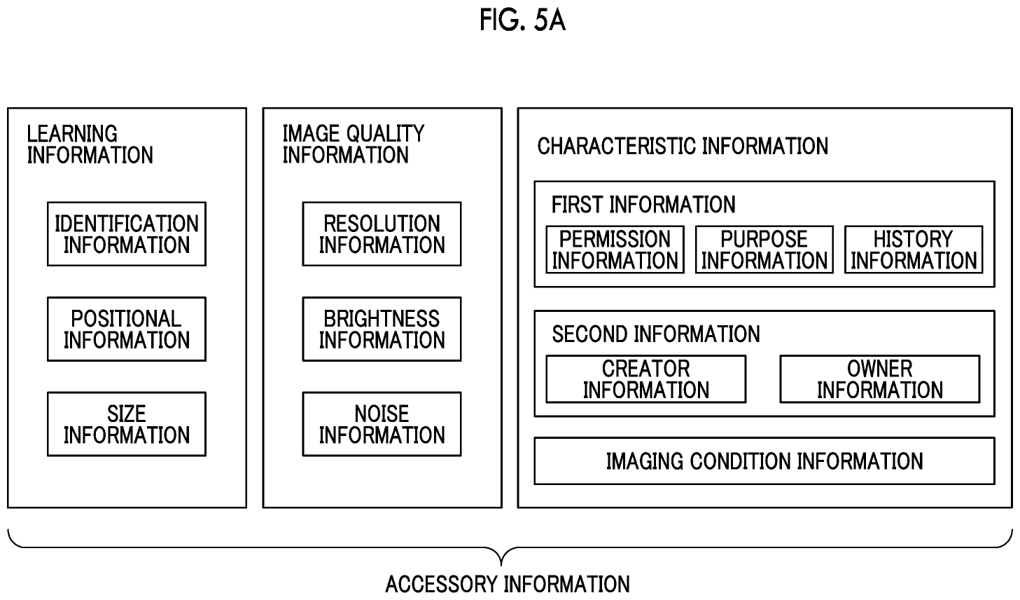

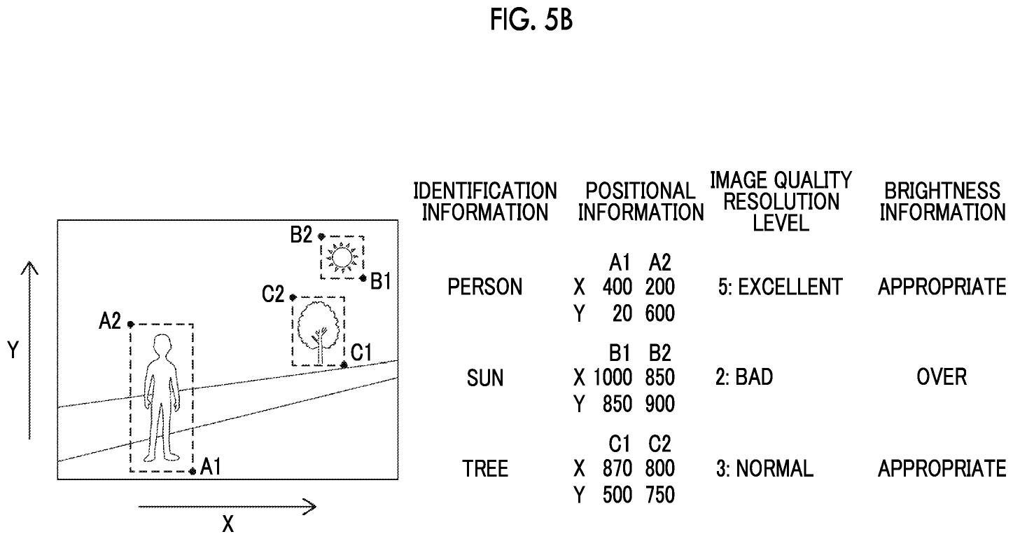

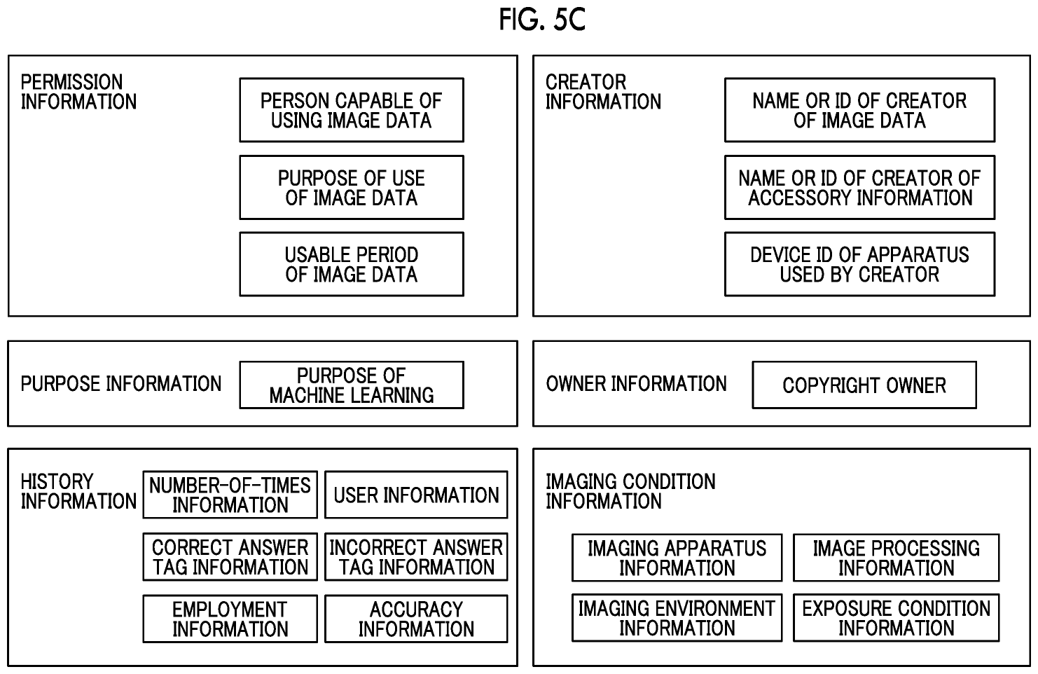

The learning information is information required for performing the machine learning. Specifically, the learning information includes identification information, positional information, size information, and the like of the subject in the image as illustrated in FIG. 5A. The identification information is a label indicating the type, the state, and a feature of the subject in the image. The positional information indicates a position of the subject in the image. Specifically, the positional information indicates a predetermined position of a rectangular region in a case where the subject is surrounded by a rectangular bounding box as illustrated in FIG. 5B. The predetermined position of the rectangular region is, for example, coordinate positions (specifically, XY coordinates) of two vertex angles present on a diagonal line of the rectangular region and is (A1, A2), (B1, B2), and (C1, C2) in the example illustrated in FIG. 5B. The size information indicates a size of a region occupied by the subject in the image and indicates, for example, a size (specifically, a length in an XY direction) of the rectangular region.

A plurality of subjects may be captured within the image indicated by one piece of image data. In this case, a plurality of pieces of the learning information are assigned in association with the plurality of subjects. That is, the identification information, the positional information, the size information, and the like are created for each subject with respect to the image data in which the plurality of subjects are captured (refer to FIG. 5B).

The learning information may be automatically assigned by the imaging apparatus 12 that has captured the image, may be assigned by inputting the learning information through the user-side apparatus 14 via the user, or may be created using an artificial intelligence (AI) function. In addition, in the case of detecting the subject in the image in assigning the learning information, a well-known subject detection function may be used.

(Image Quality Information)

The image quality information is a tag related to image quality of the subject in the image recorded in the image data and is assigned in association with the subject. Meanwhile, as described above, the identification information of the learning information is assigned to the subject in the image. That is, in a case where the image quality information is assigned to the subject in the image, the identification information is also assigned.

In addition, a plurality of subjects may be captured within the image indicated by one piece of image data. In this case, a plurality of pieces of the image quality information are assigned in association with the plurality of subjects. That is, the accessory information including a plurality of pieces of the identification information and a plurality of pieces of the image quality information assigned in association with a plurality of subjects are recorded in the image data in which a plurality of subjects are captured.

The image quality information in the present embodiment is information related to image quality of any of resolution of the subject, brightness of the subject, and noise occurring at the position of the subject in the image indicated by the image data. Specifically, any one of resolution information, brightness information, and noise information illustrated in FIG. 5A is included in the image quality information. These pieces of information are reflected on a feature amount of the image derived from the training data in the machine learning and furthermore, may affect accuracy of learning.

The resolution information is information related to the resolution of the subject and is determined in accordance with blurriness and shake levels of the subject in the image indicated by the image data. The resolution information may be a representation of a blurriness amount and a shake amount of the subject detected using a well-known technique in number of pixels, a stepwise evaluation such as a rank or a grade of 1 to 5 as illustrated in FIG. 5B, or an evaluation using a score. In addition, the resolution information may be a stepwise evaluation of the blurriness and shake levels of the subject using a scale based on sensitivity of a person, that is, an indication of a result of sensory evaluation.

The resolution information is not limited to information corresponding to the blurriness and shake levels of the subject and may be, for example, resolution level information related to a resolution level of the subject in the image indicated by the image data. The resolution level information is, for example, information indicating the number of pixels (pixel count) of the image including the subject.

The brightness information is information related to the brightness of the subject. Specifically, the brightness information indicates a brightness value corresponding to the subject. The brightness value is a value indicating brightness of each color of red, green, and blue (RGB) in the pixels in the image. The brightness value corresponding to the subject is an average value or a representative value (a maximum value, a minimum value, or a median value) of brightness values of pixels present within the rectangular region surrounding the subject in the image. The information related to the brightness of the subject is not limited to the brightness value and may be an evaluation of the brightness of the subject using a score, a stepwise evaluation such as a grade or a rank as illustrated in FIG. 5B, or a result of sensory evaluation.

The noise information is information related to the noise occurring at the position of the subject and indicates a level of noise caused by an imaging sensor of the imaging apparatus 12, specifically, a signal-to-noise ratio (S/N value) corresponding to the subject. The S/N value corresponding to the subject is an S/N value within the rectangular region surrounding the subject in the image. In the information related to the noise, information indicating whether or not white noise is present within the rectangular region surrounding the subject may be added in addition to the S/N value. In addition, an evaluation of an amount of noise occurring at the position of the subject using a score, a stepwise evaluation such as a rank or a grade, or a result of sensory evaluation may be used.

In the present embodiment, the image quality information is automatically assigned to the subject in the image by the imaging apparatus-side processor in a case where the imaging apparatus 12 captures the image. However, the present invention is not limited thereto. The image quality information may be assigned by inputting the image quality information through an input unit of the imaging apparatus 12 via an imaging person or may be assigned using an artificial intelligence (AI) function.

(Characteristic Information)

The characteristic information is a tag indicating information related to the image recorded in the image data other than the image quality. As illustrated in FIG. 5A, the characteristic information includes first information or second information and may further include imaging condition information.

The first information is information related to the machine learning. Specifically, the first information includes permission information, purpose information, or history information as illustrated in FIG. 5C. In a case where the first information is recorded in the image data, at least one of the permission information, the purpose information, or the history information may be stored. It is desirable to perform, for example, encryption or hashing with respect to these pieces of information to avoid unauthorized alteration, thereby ensuring security.

The permission information is information related to permission to use the image data in creating the training data in the machine learning. As illustrated in FIG. 5C, the permission information may be information related to a person related to permission of the image data, for example, a person capable of using the image data. Examples of the permission information in this case correspond to information for restricting use for a specific person, such as “usable by only Person A” or “usable by only Company B”, and information indicating that there is no user restriction, such as “usable by any person”.

In addition, the permission information may be information related to an aim of use of the image data as illustrated in FIG. 5C. Examples of the permission information in this case correspond to information for restricting a specific aim of use, such as “commercial use is restricted”, and information indicating that there is no aim restriction, such as “usable for any aim”.

Furthermore, the permission information may include information related to a usable period of the image data in addition to the information related to the person capable of using or to the aim of use. Specifically, information related to restriction of a time of use, for example, expiration of the image data or a period in which the image data can be used without payment or on payment, may be included in the permission information.

The purpose information is information related to a purpose of the machine learning (learning purpose). Specifically, the purpose information indicates the purpose of the machine learning in which the training data created from the image data is used. In addition, the learning purpose of the machine learning in which the training data created based on the image data is used can be specified in a case where the purpose information recorded in the image data is referred to.

The history information is information related to a history of use as the training data in the machine learning in the past, that is, a history of use of the image data for creating the training data. The history information corresponds to, for example, number-of-times information, person-of-use information, correct answer tag information, incorrect answer tag information, employment information, and accuracy information as illustrated in FIG. 5C.

The number-of-times information is information indicating the number of times the machine learning is performed using the training data created based on the image data.

The person-of-use information is information indicating a person (person of use) who has made the request to perform the machine learning with respect to the machine learning performed in the past using the training data created based on the image data.

The correct answer tag information and the incorrect answer tag information are information related to whether or not the training data is used as the correct answer data with respect to the machine learning performed in the past using the training data created based on the image data.

Specifically, in a case where the training data in the machine learning in the past is used as the correct answer data, the correct answer tag information is assigned to the image data used for creating the training data. More specifically, in a case where the subject in the image recorded in the image data is a subject that coincides with the purpose of the machine learning in the past, that is, the correct answer subject, the correct answer tag information is assigned to the image data.

Meanwhile, in a case where the training data in the machine learning in the past is used as the incorrect answer data, the incorrect answer tag information is assigned to the image data used for creating the training data. More specifically, in a case where the subject in the image recorded in the image data is a subject different from the correct answer subject, the incorrect answer tag information is assigned to the image data.

The correct answer tag information and the incorrect answer tag information are assigned in association with the purpose information.

The employment information is information related to whether or not the training data corresponding to the incorrect answer data is employed. Specifically, the employment information is information indicating whether or not the machine learning is performed using the training data created from the image data to which the incorrect answer tag information is assigned.

The accuracy information is information related to prediction accuracy of the inference model obtained by performing the machine learning using the incorrect answer data. Specifically, the accuracy information indicates a result of comparison with accuracy in a case where the incorrect answer data is not used, that is, a difference.

The history information is stored in association with the setting condition and the additional condition, described later. In other words, the history information is assigned to the selection image data satisfying the setting condition and to the additional image data satisfying the additional condition. Here, a correspondence relationship between the setting condition and the additional condition and the plurality of pieces of image data (image data group G) to which the history information is assigned may be stored in the data file T separate from each image data (refer to FIG. 4).

In the first information, the permission information is automatically created by the imaging apparatus-side processor in a case where the imaging apparatus 12 captures the image. However, the present invention is not limited thereto. The permission information may be created by inputting the permission information through the input unit of the imaging apparatus 12 via the imaging person or may be created using an artificial intelligence (AI) function.

In addition, in the first information, the purpose information and the history information are automatically created by a function of the data creation apparatus 10 or the learning apparatus 16 when the training data is created or when the machine learning is performed. However, the present invention is not limited thereto. The purpose information and the history information may be created by inputting the purpose information and the history information through the user-side apparatus 14 via the user or may be created using an artificial intelligence (AI) function.

The second information is creator information and owner information illustrated in FIG. 5A and strictly, includes at least one of these pieces of information.

As illustrated in FIG. 5C, the creator information is information related to a creator of the image data or to a creator of the accessory information and is, for example, a name or ID information of each creator. The creator information may be a device ID of an apparatus (specifically, the imaging apparatus 12 or the user-side apparatus 14) used for creating the image data or the accessory information.

The creator of the image data is the imaging person of the image indicated by the image data, that is, the owner of the imaging apparatus 12 used for capturing the image. The creator of the accessory information is the creator of the accessory information recorded in the image data and normally matches the creator of the image data. However, the creator of the accessory information may be different from the creator of the image data. In addition, the creator of the accessory information may be a creator of the learning information described above. In this case, the second information may include creator information related to the creator of the learning information as the creator information related to the creator of the accessory information.

The owner information is information related to a right holder of the image data. Specifically, the owner information is information related to a copyright owner of the image data as illustrated in FIG. 5C. Normally, the copyright owner of the image data matches the creator of the image data, that is, the imaging person. However, the copyright owner may be different from the creator of the image data. Examples of the owner information correspond to information indicating the copyright owner of the image data, such as “Person A is the copyright holder”, and information indicating that there is no right holder, such as “copyright-free”.

The imaging condition information is information related to the imaging condition of the image and, as illustrated in FIG. 5C, includes information related to at least one of an apparatus that has captured the image (that is, the imaging apparatus 12), image processing performed with respect to the image by the apparatus, or an imaging environment of the image.

The information related to the imaging apparatus 12 corresponds to a manufacturer of the imaging apparatus 12, a model name of the imaging apparatus 12, a type of light source of the imaging apparatus 12, and the like.

The information related to the image processing corresponds to a name of the image processing, a feature of the image processing, a model of an apparatus that can execute the image processing, a region on which the processing is performed in the image, and the like.

The information related to the imaging environment corresponds to a date and time of imaging, a season, weather during imaging, a place name of an imaging location, illuminance (amount of solar radiation) in the imaging location, and the like.

In addition, the imaging condition information may further include information other than the above information, for example, an exposure condition during imaging (specifically, an f number, ISO sensitivity, and a shutter speed).

<<Creation Procedure of Training Data According to Present Embodiment>>

In a data processing method according to the present embodiment, the setting condition on which intention of the user who has made the request to perform the machine learning is reflected is set, the image data satisfying the setting condition is selected as the selection image data, and the training data is created based on the selection image data. Hereinafter, a creation procedure of the training data, that is, the data creation flow, according to the present embodiment will be described.

The data creation flow described below is merely an example. Unnecessary steps may be deleted, new steps may be added, or an order in which steps are performed may be changed without departing from the gist of the present invention.

In the present embodiment, the selection image data is selected by referring to the accessory information recorded in each of the plurality of pieces of image data. Here, the data creation flow of the present embodiment is broadly divided into a flow (hereinafter, a first flow) of selecting by referring to the characteristic information and a flow (hereinafter, a second flow) of selecting by referring to the image quality information in the accessory information. Hereinafter, each of the first flow and the second flow will be described.

(First Flow)

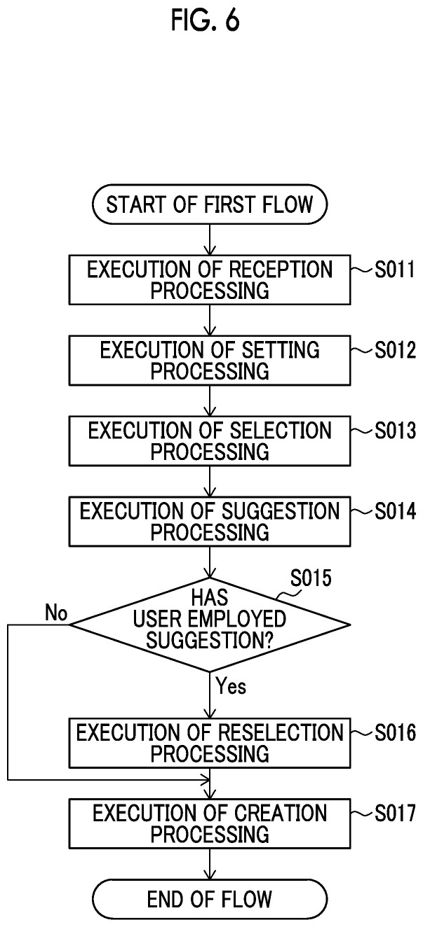

The first flow progresses in accordance with the flow illustrated in FIG. 6. In each step of the first flow, the processor 10A of the data creation apparatus 10 executes data processing corresponding to each step.

In addition, while illustration is not provided in FIG. 6, the processor 10A executes the acquisition processing of acquiring the plurality of pieces of image data before the start of the flow or in the middle of the flow. In the acquisition processing, the image data in which the accessory information is recorded is acquired. In the case of the first flow, the image data in which the accessory information including the characteristic information is recorded is acquired. The accessory information of the image data acquired through the acquisition processing includes at least the first information or the second information as the characteristic information and may further include the imaging condition information. In addition, the accessory information further includes the learning information.

In the first flow, first, the processor 10A executes reception processing (S011). In the reception processing, the user who has made the request to perform the machine learning performs an input operation for searching for (extracting) the image data for creating the training data through the user-side apparatus 14. The processor 10A receives the input operation by communicating with the user-side apparatus 14.

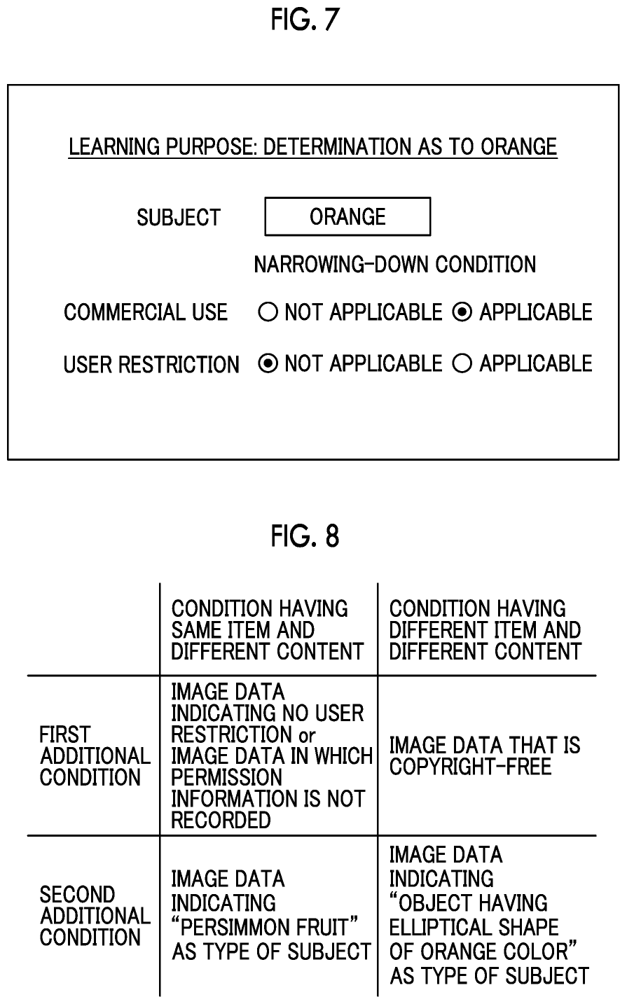

For example, the input operation performed by the user is performed through the input screen in FIG. 7 displayed on the display of the user-side apparatus 14. Information input by the user includes information corresponding to the learning purpose (that is, the determination purpose) designated by the user. For example, information indicating the subject coinciding with the determination purpose, that is, the correct answer subject, is included. For example, in a case where the determination purpose is “determination as to whether or not the subject is an orange fruit”, the user inputs “orange” as the correct answer subject.

In addition, the user inputs information for narrowing down the image data for creating the training data through the input screen. In the example illustrated in FIG. 7, “applicability of commercial use” and “applicability of user restriction” are input as the information for narrowing down the image data. The information for narrowing down the image data is not limited to the above information and may include the learning information and the characteristic information (for example, the imaging condition information) other than the above information.

Next, the processor 10A executes setting processing (S012). Step S012 corresponds to a setting step. In the setting processing, the processor 10A sets any setting condition with respect to the plurality of pieces of image data accumulated in the storage device 18 based on the input operation received through the reception processing.

Here, setting the setting condition means setting each of an item and content of the setting condition. The item is a perspective (viewpoint) in narrowing down the image data to be used for creating the training data, and the content is a specific concept to which the image data corresponds with respect to the item. In the example illustrated in FIG. 7, “correct answer subject”, “applicability of commercial use”, and “applicability of user restriction” correspond to the item of the setting condition, and “orange”, “commercial use applicable”, and “user restriction not applicable” are the respective content of the items.

In the setting processing of the first flow, the processor 10A sets the setting condition related to the characteristic information with respect to the image data in which the accessory information including the characteristic information is recorded. Specifically, any setting condition related to the first information or to the second information is set. In the example illustrated in FIG. 7, a setting condition of “image data indicating “orange” as the type of the subject, “commercial use applicable”, and “user restriction not applicable”” is set.

The setting condition related to the first information or to the second information corresponds to a first setting condition.

To describe the setting condition (first setting condition) in detail, the person capable of using and the aim of use indicated by the permission information can be set as the items of the setting condition as in the example illustrated in FIG. 7. The setting condition is set in accordance with the content input by the user with respect to these items. In this case (hereinafter, a first A case), the image data for creating the training data can be narrowed down from the viewpoint of restriction of use of the image data, that is, whether or not data can be used. Particularly, in a case where the image data is narrowed down from the viewpoint of the person capable of using, the image data can be narrowed down to image data that can be rightfully used by the user.

In the first A case, conditions related to each of the person capable of using and the aim of use may be individually set, and a union of these conditions may be set as the setting condition. Alternatively, an intersection of the conditions may be set as the setting condition. In addition, the setting condition may be set in the form of further adding the usable period with respect to any one of the person capable of using or the aim of use or to both of the person capable of using and the aim of use.

In addition, the learning purpose indicated by the purpose information, that is, the purpose of the machine learning performed in the past using the training data created based on the image data, can be set as an item of the setting condition, and the setting condition can be set in accordance with content input by the user with respect to the item. In this case (hereinafter, a first B case), the image data can be narrowed down from the viewpoint of the learning purpose. Specifically, the image data can be narrowed down to image data that coincides with the purpose designated by the user.

In addition, the history of use in the past indicated by the history information, that is, the history of use as the training data in the machine learning performed in the past for the same purpose as the determination purpose, can be set as an item of the setting condition. Specifically, whether or not the training data is used for creating the correct answer data in the machine learning in the past can be set as an item of the setting condition. The setting condition may be set in accordance with content input by the user with respect to the item. In this case (hereinafter, a first C case), the image data for creating the training data can be narrowed down from the viewpoint of the history of use as the training data in the machine learning in the past, specifically, whether or not the training data is used for creating the correct answer data.

In addition, the creator of the image data or the creator of the accessory information indicated by the creator information can be set as an item of the setting condition, and the setting condition may be set in accordance with content input by the user with respect to the item. In this case (hereinafter, a first D case), the image data for creating the training data can be narrowed down from the viewpoint of who is the creator of the image data or the creator of the accessory information.

In addition, the copyright owner of the image data indicated by the owner information can be set as an item of the setting condition, and the setting condition may be set in accordance with content input by the user with respect to the item. In this case (hereinafter, a first E case), the image data for creating the training data can be narrowed down from the viewpoint of who is the copyright owner of the image data.

In the setting processing of the first flow, conditions may be set from each of the viewpoints of the five cases (first A to first E cases), and a union of the conditions from each viewpoint may be set as the setting condition. Alternatively, an intersection of conditions set from each of two or more viewpoints may be set as the setting condition. In addition, a plurality of conditions may be set by changing the content with the same viewpoint (item), and a union of the plurality of conditions may be set as the setting condition.

In addition, in the setting processing of the first flow, any setting condition (hereinafter, a second setting condition) related to the imaging condition information may be set in addition to setting of the setting condition (first setting condition) from the above viewpoint. That is, the imaging condition may be added to the item of the setting condition, and the second setting condition may be set in accordance with content input by the user with respect to the imaging condition. Accordingly, the image data for creating the training data can be narrowed down by taking the imaging condition into consideration. For example, the image data can be narrowed down to image data captured under an imaging condition suitable for the machine learning.

Furthermore, in the setting processing of the first flow, any setting condition (hereinafter, a third setting condition) related to the learning information, more specifically, the positional information or the size information of the subject, may be further set. That is, the position, the size, or the like of the subject in the image may be added to the item of the setting condition, and the third setting condition may be set in accordance with content input by the user with respect to these items. Accordingly, the image data for creating the training data can be narrowed down based on the position or the size of the subject in the image.

After the setting condition is set in the above manner, the processor 10A executes the selection processing (S013). In the selection processing, the selection image data is selected from the plurality of pieces of image data stored in the storage device 18. In the first flow, the selection image data is the image data in which the characteristic information including the first information or the second information satisfying the setting condition set through the setting processing is recorded. In the selection processing, normally two or more pieces of the selection image data are selected. At this point, an amount of the selection image data required for the machine learning performed later may be selected.

In addition, in a case where the first setting condition and the second setting condition are set through the setting processing, the image data in which the first information or the second information satisfying the first setting condition and the imaging condition information satisfying the second setting condition are recorded is selected as the selection image data in the selection processing. In addition, in a case where the first setting condition and the third setting condition are set through the setting processing, the image data in which the first information or the second information satisfying the first setting condition and the learning information satisfying the third setting condition are recorded is selected as the selection image data in the selection processing.

In the first flow, the processor 10A executes suggestion processing after executing the selection processing (S014). The suggestion processing is processing of suggesting the additional condition different from the setting condition set through the setting processing to the user.

The additional condition is a condition set for selecting the additional image data from the image data (hereinafter, non-selection image data) not selected in the selection processing. The non-selection image data is the image data of which the first information or the second information does not satisfy the setting condition in the image data stored in the storage device 18.

In addition, the additional condition is a condition related to the accessory information, that is, at least one of the characteristic information, the image quality information, or the learning information, recorded in the image data. The additional condition suggested through the suggestion processing of the first flow is preferably a condition related to the characteristic information. Particularly, the additional condition is more preferably a condition related to the first information or to the second information.

The additional condition includes a first additional condition and a second additional condition, and each additional condition is set in association with the setting condition. The first additional condition is set as a condition obtained by relaxing or changing the setting condition for the reason of supplementing the selection image data selected based on the setting condition. The second additional condition is set to select the incorrect answer data, strictly, the incorrect answer data indicating an image in which a subject similar to the correct answer subject is captured, as the additional image data in order to improve the accuracy of the machine learning.

Each of the first additional condition and the second additional condition may be a condition having the same item as the setting condition and different content from the setting condition or may be a condition having a different item and different content from the setting condition.

As a specific example, a scene in which “determination as to whether or not the subject is an orange fruit” is set as the determination purpose and a setting condition of “image data indicating “orange” as the type of the subject, “commercial use applicable”, and “user restricted to Person A”” is set is assumed. In this case, the first additional condition having the same item as the setting condition and different content from the setting condition corresponds to, for example, “image data of which use is not restricted” or to “image data in which the permission information is not recorded” as illustrated in FIG. 8. In addition, the first additional condition having a different item and different content from the setting condition corresponds to, for example, “image data that is copyright-free” as illustrated in FIG. 8.

Meanwhile, the second additional condition having the same item as the setting condition and different content from the setting condition corresponds to, for example, “image data indicating a persimmon fruit as the subject” as illustrated in FIG. 8. In addition, examples of the second additional condition having a different item and different content from the setting condition include “image data indicating an object having an elliptical shape of an orange color” as illustrated in FIG. 8.

In addition, the additional condition may be set to be an imaging condition different from the setting condition (second setting condition) set with respect to the imaging condition for the reason of being able to correctly identify the subject imaged under various imaging conditions.

The additional condition is set on the processor 10A side based on the setting condition. For example, table data that defines a correspondence relationship between the setting condition and the additional condition may be prepared in advance, and the processor 10A may set the additional condition corresponding to the setting condition set through the setting processing based on the table data. In addition, in a case where there is a person (hereinafter, a previous learner) who performed the machine learning in the past under the same setting condition as the setting condition set through the setting processing, the additional condition employed by the previous learner may be set as the additional condition to be suggested through the suggestion processing.

In addition, the additional condition may be set based on a feature of the image, specifically, a feature (for example, a shape of contours, a color, and a pattern) of the subject in the image, recorded in the image data satisfying the setting condition. In addition, the additional condition may be set by making the setting condition more abstract (to be a higher-level concept).

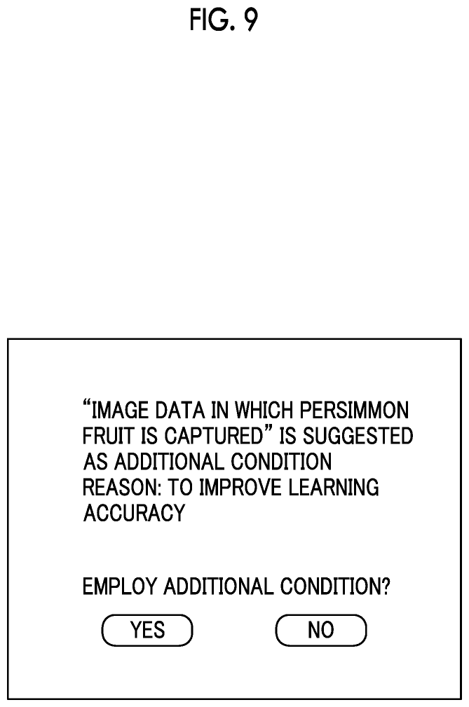

In the suggestion processing, the additional condition set in the above manner is displayed on the display of the user-side apparatus 14 together with a reason for suggestion of the additional condition, as illustrated in FIG. 9. Accordingly, the user can perceive the reason for suggesting the additional condition. Examples of the reason for suggestion include “increase in the number of pieces of the training data”, “improvement in the accuracy of learning”, “condition employed by the previous learner”, and “adding the incorrect answer data achieves a better result”.

In the suggestion processing, the user selects whether or not to employ the suggested additional condition (S015). In a case where the user has selected to employ the additional condition, the processor 10A executes reselection processing (S016). In the reselection processing, the additional image data is selected from a plurality of pieces of the non-selection image data under the employed additional condition. The additional image data is the image data of which the accessory information satisfies the additional condition in the non-selection image data.

After executing the selection processing and the reselection processing, the processor 10A executes creation processing (S017). Step S017 corresponds to a creation step. In the creation processing, the training data is created from the selected image data. Here, in a case where the user has not employed the additional condition suggested through the suggestion processing, the training data is created in the creation processing based on the selection image data selected through the selection processing. Meanwhile, in a case where the suggested additional condition is employed and the additional image data is additionally selected through the reselection processing, the training data is created in the creation processing based on each of the selection image data and the additional image data.

In the case of executing the reselection processing as described above, the number of pieces of the training data can be increased by a number corresponding to an increase in the number of pieces of the additional image data. Consequently, the accuracy of the machine learning performed using the training data is improved. Particularly, in a case where the number of pieces of the training data corresponding to the incorrect answer data is increased, the learning accuracy can be effectively improved.

In addition, in a case where additional learning data selected under the additional condition employed by the previous learner is used, the training data in the machine learning performed by the previous learner can be obtained. Accordingly, for example, the machine learning performed in the past by a business partner can be reproduced, or higher-level machine learning can be performed.

When the processing so far ends, the first flow ends. After the end of the first flow, the machine learning based on the determination purpose is performed using the training data created in the first flow. In addition, in the image data used for creating the training data, the accessory information is updated. Specifically, the purpose information, the history information, and the like are updated. Accordingly, in the subsequent data creation flow, the image data for creating the training data can be selected based on the updated accessory information. That is, appropriate image data can be selected by considering records used for creating the training data, the number of times the machine learning is performed using the training data, the accuracy of the machine learning, and the like, and the training data can be created based on the image data.

While the suggestion processing is executed after the selection processing in the flow illustrated in FIG. 6, the present invention is not limited thereto. The suggestion processing may be executed between the setting processing and the selection processing. In this case, in a case where the user has employed the additional condition suggested through the suggestion processing, both of the selection image data and the additional image data may be selected at the same timing in the subsequent selection processing.

In addition, the suggestion processing does not necessarily need to be executed. For example, execution of the suggestion processing may be omitted in a case where a sufficient number of pieces of the selection image data are selected in the selection processing, that is, in a case where the number of pieces of the training data can be sufficiently secured.

(Second Flow)

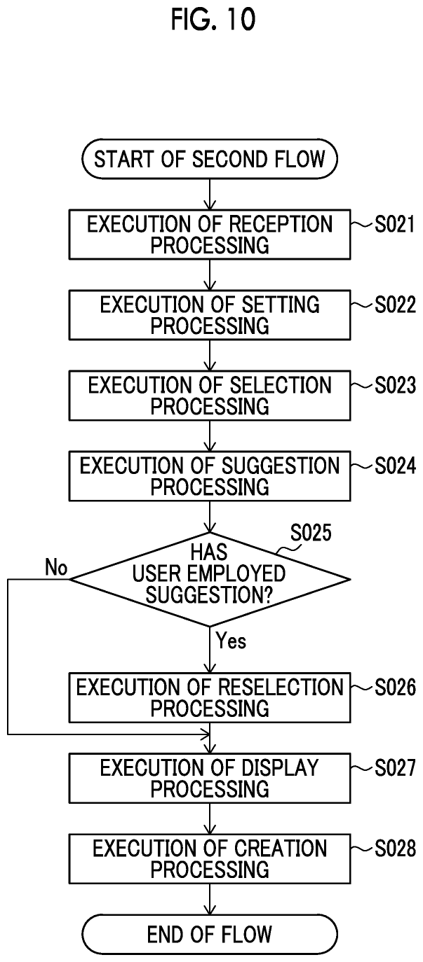

The second flow progresses in accordance with the flow illustrated in FIG. 10. In each step of the second flow, the processor 10A of the data creation apparatus 10 executes data processing corresponding to each step.

In addition, while illustration is not provided in FIG. 10, the processor 10A executes the acquisition processing of acquiring the plurality of pieces of image data before the start of the flow or in the middle of the flow. In the acquisition processing, the image data in which the accessory information is recorded in the image in which a plurality of subjects are captured is acquired. Specifically, the image data in which the accessory information including the identification information and the image quality information assigned in association with the plurality of subjects in the image is recorded is acquired. The accessory information of the acquired image data includes the learning information and may further include the characteristic information. In this case, the learning information (that is, the identification information, the positional information, and the size information) is assigned for each subject and is assigned in association with the plurality of subjects.

As illustrated in FIG. 10, the second flow is almost the same as the first flow. That is, even in the second flow, the reception processing, the setting processing, and the selection processing are executed in this order (S021 to S023), and then the suggestion processing is executed (S024). In a case where the suggested additional condition is employed by the user (S025), the reselection processing based on the additional condition is executed (S026).

In the second flow, after execution of the selection processing or the reselection processing, display processing, described later, is executed (S027), and then the creation processing is executed (S028). In the creation processing in a case where the reselection processing is not executed, the training data is created based on the selection image data. In the creation processing in a case where the reselection processing is executed, the training data is created based on each of the selection image data and the additional image data.

In the second flow, step S022 in which the setting processing is executed corresponds to the setting step, and step S028 in which the creation processing is executed corresponds to the creation step. In addition, while the suggestion processing is executed after the selection processing in the flow illustrated in FIG. 10, the present invention is not limited thereto. The suggestion processing may be executed between the setting processing and the selection processing. In this case, in a case where the user has employed the additional condition suggested through the suggestion processing, both of the selection image data and the additional image data may be selected at the same timing in the subsequent selection processing.

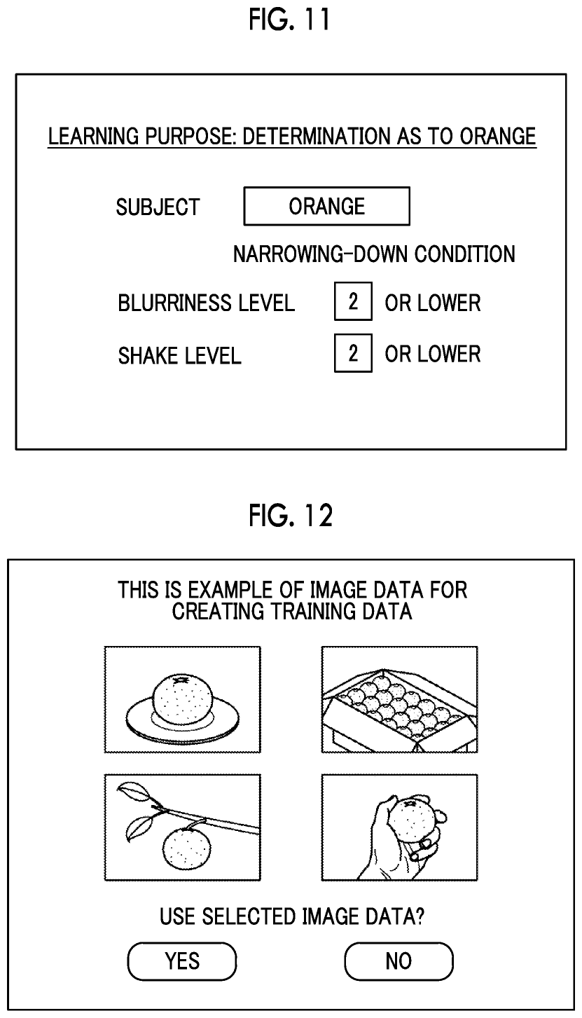

In the setting processing, in the same manner as the first flow, any setting condition is set with respect to the plurality of pieces of image data accumulated in the storage device 18 based on the input operation of the user received through the reception processing. In the setting processing of the second flow, the setting condition related to a plurality of pieces of the identification information and a plurality of pieces of the image quality information assigned in association with the plurality of subjects in the image is set. For example, in a case where the user has performed the input operation as illustrated in FIG. 11, a setting condition of “image data indicating “orange” as the type of the subject, “blurriness level of 2 or lower”, and “shake level of 2 or lower”” is set.

To describe the setting condition in the second flow in detail, information corresponding to the resolution of the subject, specifically, the blurriness and shake levels, indicated by the resolution information included in the image quality information can be set as an item of the setting condition as in the example illustrated in FIG. 11. The setting condition may be set in accordance with content input by the user with respect to these items. Specifically, numerical value ranges (in the example illustrated in FIG. 11, blurriness level 2 or lower” and “shake level 2 or lower”) of scores or ranks corresponding to the blurriness and shake levels may be set as the setting condition. In this case (hereinafter, a second A case), the image data for creating the training data can be appropriately narrowed down from the viewpoint of the resolution of the subject, specifically, the blurriness and shake levels of the subject.

In addition, in a case where the resolution information includes the resolution level information of the subject, the resolution level (number of pixels) indicated by the resolution level information can be set as an item of the setting condition, and the setting condition may be set in accordance with content input by the user with respect to the item. Specifically, the setting condition including a condition related to an upper limit and a lower limit of the resolution level, that is, a numerical value range of the resolution level, may be set. In this case (hereinafter, a second B case), the image data for creating the training data can be appropriately narrowed down from the viewpoint of the resolution level of the subject.

In the second A case and the second B case, the training data can be created from the image data having favorable image quality by narrowing down the image data for creating the training data from the viewpoint of the resolution level of the subject. Consequently, the learning accuracy in the machine learning is improved.

In addition, in the second B case, as the resolution level of the subject is increased, a capacity of the training data created using the image data of the image in which the subject is captured is increased, and an amount of learning in the machine learning using the training data is increased. Considering this point, a condition including the upper limit and the lower limit of the resolution level of the subject is preferably set as the setting condition as in the second B case.

The image quality information related to the brightness of the subject, specifically, the brightness value corresponding to the subject indicated by the brightness information, can be set as an item of the setting condition. The setting condition may be set in accordance with content input by the user with respect to the item. Specifically, the setting condition including a condition related to an upper limit and a lower limit of the brightness value, that is, a numerical value range of the brightness value, may be set. In this case (hereinafter, a second C case), the image data for creating the training data can be appropriately narrowed down from the viewpoint of the brightness value corresponding to the subject. For example, the image data can be narrowed down to the image data of which the brightness value is within a suitable range. Consequently, the learning accuracy in the machine learning is improved.

In addition, the image quality information related to the noise occurring at the position of the subject, specifically, the S/N value corresponding to the subject indicated by the noise information, can be set as an item of the setting condition. The setting condition may be set in accordance with content input by the user with respect to the item. Specifically, the setting condition including a condition related to an upper limit and a lower limit of the S/N value, that is, a numerical value range of the S/N value, may be set. In this case (hereinafter, a second D case), the image data for creating the training data can be appropriately narrowed down from the viewpoint of the S/N value corresponding to the subject. For example, the image data can be narrowed down to the image data of which the S/N value is within a suitable range. Consequently, the learning accuracy in the machine learning is improved.

In the setting processing of the second flow, conditions may be set from each of the viewpoints of the four cases (second A to second D cases), and a union of the conditions from each viewpoint may be set as the setting condition. Alternatively, an intersection of conditions set from each of two or more viewpoints may be set as the setting condition.

In addition, in the setting processing of the second flow, any setting condition related to the learning information, more specifically, the positional information or the size information of the subject, may be further set. That is, the position, the size, or the like of the subject in the image may be added to the item of the setting condition, and the setting condition may be set in accordance with content input by the user with respect to these items. Accordingly, the image data for creating the training data can be narrowed down based on the position or the size of the subject in the image.

In the second flow, the selection processing is executed after execution of the setting processing. In the selection processing, the processor 10A selects the selection image data in which the identification information and the image quality information satisfying the setting condition are recorded. More specifically, in the selection processing of the second flow, the image data of which the identification information and the image quality information associated with at least a part of the subjects among the plurality of subjects captured in the image recorded in each image data satisfy the setting condition is selected as the selection image data.

The additional condition suggested through the suggestion processing of the second flow is a condition that is set with respect to the accessory information, that is, at least one of the characteristic information, the image quality information, or the learning information, of the image data and that corresponds to the learning purpose (determination purpose) designated by the user. The additional condition suggested through the suggestion processing of the second flow is preferably a condition set with respect to the image quality information.

Examples of the additional condition in the second flow include a condition that is set for the aim of creating the training data in which the image quality of the correct answer subject is intentionally decreased. The additional condition in this case is a condition in which the resolution is set to be lower than that in the setting condition or a condition in which an allowable level with respect to the noise (upper limit of the S/N value) is set to be higher than that in the setting condition.

The additional condition in the second flow is set in the same manner as the first flow. The processor 10A sets the first additional condition or the second additional condition included in the additional condition in association with the setting condition. Each of the first additional condition and the second additional condition may be a condition having the same item as the setting condition and different content from the setting condition or may be a condition having a different item and different content from the setting condition.

In addition, even in the suggestion processing of the second flow, the additional condition is displayed on the display of the user-side apparatus 14 together with the reason for suggestion of the additional condition in the same manner as the first flow.

In the second flow, in a case where the user has selected to employ the additional condition, the reselection processing is executed. In the reselection processing, the additional image data is selected from the plurality of pieces of the non-selection image data under the employed additional condition. The non-selection image data in the second flow is the image data of which the identification information and the image quality information do not satisfy the setting condition among the plurality of pieces of image data accumulated in the storage device 18. Specifically, the image data of which the identification information and the image quality information do not satisfy the setting condition with respect to all of the plurality of subjects captured in the image of the image data corresponds to the non-selection image data.

In the second flow, the display processing is executed after execution of the selection processing or the reselection processing. In the display processing, the processor 10A displays the image recorded in the selection image data on the display of the user-side apparatus 14 as illustrated in FIG. 12. The user who has made the request to perform the machine learning can view the display image and check the image quality of the selection image data, that is, the image data for creating the training data.

In a case where the user has determined that the image quality of the selection image data is not preferable after viewing the displayed image, the user can make a request to perform the selection processing again. In this case, the processor 10A sets the setting condition again and executes the selection processing again based on the reset setting condition.

In the selection processing in the second flow, normally two or more pieces of the selection image data are selected. A large number of pieces of selection data may be selected depending on the setting condition. In this case, images of all of the selected pieces of the selection image data can be displayed in the display processing. However, this burdens checking of the user. Considering this point, a part of the selection image data among the two or more pieces of the selection image data may be selected, and the image recorded in the selected selection image data may be displayed in the display processing.

In the above case, the part of the selection image data of which the image is displayed through the display processing may be selected based on a priority order set for each of the two or more pieces of the selection image data. For example, images recorded in data up to an m-th (m is a natural number) piece of the selection image data in a descending priority order may be displayed through the display processing. The number of displayed images (that is, the number m of selected pieces of the selection image data) can be determined to be any number and may be at least 1 or more.

The priority order for each selection image data may be determined in accordance with the size of the subject coinciding with the determination purpose, that is, the size of the correct answer subject (specifically, the size of the rectangular region surrounding the correct answer subject) in the image. Alternatively, the priority order may be determined in accordance with the number of records or the like of use as the training data in the machine learning in the past.

In addition, in the display processing, a sample image corresponding to the image recorded in the selection image data may be displayed instead of the image recorded in the selection image data. The sample image is recorded in advance in the data creation apparatus 10, and a plurality of the sample images are prepared by changing the image quality. The processor 10A may select the sample image satisfying the setting condition set through the setting processing among the plurality of sample images and execute the display processing of displaying the selected sample image.

After the end of the display processing, the processor 10A executes the creation processing and creates the training data based on the selection image data or based on each of the selection image data and the additional image data.

When the processing so far ends, the second flow ends. After the end of the second flow, the machine learning based on the determination purpose is performed using the training data created in the second flow. In addition, in the image data used for creating the training data, the accessory information is updated. Specifically, the purpose information, the history information, and the like are updated. Accordingly, in the subsequent data creation flow, the image data for creating the training data can be selected based on the updated accessory information.

Even in the second flow, the suggestion processing does not necessarily need to be executed. For example, execution of the suggestion processing may be omitted in a case where a sufficient number of pieces of the selection image data are selected in the selection processing.

### OTHER EMBODIMENTS

The embodiment described so far is a specific example for understandable description of a data creation apparatus, a data creation method, a program, a data processing system, a storage device, and an imaging apparatus according to the embodiment of the present invention and is merely an example. Other embodiments are also considered.

In addition, while the accessory information recorded in the image data includes the learning information and includes at least one of the characteristic information or the image quality information in the above embodiment, the accessory information may further include information (tag information) other than the above information.

In addition, in the above embodiment, the processor 10A of the data creation apparatus 10 sets the setting condition based on the input operation of the user in the setting processing. However, the present invention is not limited thereto. The setting condition may be automatically set on the processor 10A side independently of the input operation of the user. For example, the processor 10A may set the setting condition corresponding to the learning purpose (that is, the determination purpose) designated by the user. Specifically, the setting condition corresponding to the learning purpose may be set in advance for each learning purpose and be stored as table data, and the processor 10A may read out the table data and set the setting condition corresponding to the determination purpose.

In addition, a correspondence relationship between the purpose of the machine learning performed in the past and the setting condition for creating the training data in the machine learning may be specified using the machine learning, and the setting condition corresponding to the determination purpose may be set based on the correspondence relationship. In this case, the correspondence relationship may incorporate information about a person who has performed the machine learning, that is, the user. Accordingly, in newly setting the setting condition, the setting condition can be set by considering the setting condition that has been employed so far by the user.

In addition, in a case where there is a person (previous learner) who performed the machine learning in the past for the same learning purpose as the determination purpose, the processor 10A may set the same condition as the setting condition employed by the previous learner as the setting condition in the setting processing.

Furthermore, the processor 10A may temporarily set the setting condition corresponding to the determination purpose in the setting processing and then suggest the temporary setting condition to the user by, for example, displaying the temporary setting condition on the display of the user-side apparatus 14. In this case, in a case where the user has employed the suggested temporary setting condition, the processor 10A may set the temporary setting condition as a regular setting condition.

In addition, in the above embodiment, after the plurality of pieces of image data are acquired, the selection image data satisfying the setting condition is selected from the acquired plurality of pieces of image data. However, the present invention is not limited thereto. The image data satisfying the setting condition, that is, the selection image data, may be downloaded at once from an external image database to be acquired in a stage after the setting condition is set.

In addition, the processors comprised in each of the data creation apparatus 10 and the learning apparatus 16 may include various processors other than the CPU. The various processors other than the CPU include, for example, a programmable logic device (PLD) such as a field programmable gate array (FPGA) that is a processor having a circuit configuration changeable after manufacture. In addition, a dedicated electric circuit or the like such as an application specific integrated circuit (ASIC) that is a processor having a circuit configuration dedicatedly designed to perform specific processing is included.

In addition, one function of the data creation apparatus 10 may be configured by any one processor among the above processors. Alternatively, one function may be configured by a combination of two or more processors of the same type or different types, for example, a combination of a plurality of FPGAs or a combination of an FPGA and a CPU. In addition, each of a plurality of functions of the data creation apparatus 10 may be configured by corresponding one processor among the above processors. Alternatively, two or more functions among the plurality of functions may be configured by one processor. In addition, a form in which a combination of one or more CPUs and software is used as one processor and the plurality of functions are implemented by the processor may be provided.

In addition, for example, as represented by a system on chip (SoC) or the like, a form of using a processor that implements all of the plurality of functions comprised in the data creation apparatus 10 in one integrated circuit (IC) chip may be provided. In addition, a hardware configuration of the above various processors may be an electric circuit (circuitry) in which circuit elements such as semiconductor elements are combined.

### EXPLANATION OF REFERENCES

10: data creation apparatus
10A: processor
10B: memory
10C: communication interface
12: imaging apparatus
14: user-side apparatus
16: learning apparatus
16A: processor
16B: memory
16C: communication interface
18: storage device
G: image data group
N: network
S: data processing system
T: data file

What is claimed is:

1. A data creation apparatus that creates training data used in machine learning from image data in which accessory information is recorded in an image in which a plurality of subjects are captured, the data creation apparatus being configured to execute:
setting processing of setting any setting condition related to identification information and to image quality information with respect to a plurality of pieces of image data in which the accessory information including a plurality of pieces of the identification information assigned in association with the plurality of subjects and a plurality of pieces of the image quality information assigned in association with the plurality of subjects is recorded; and
creation processing of creating the training data based on selection image data in which the identification information and the image quality information satisfying the setting condition are recorded.

2. The data creation apparatus according to claim 1,
wherein the image quality information is information related to any of resolution of the subject in the image indicated by the image data, brightness of the subject, and noise occurring at a position of the subject.

3. The data creation apparatus according to claim 2,
wherein the image quality information is resolution information related to the resolution, and
the resolution information is information determined in accordance with blurriness and shake levels of the subject in the image indicated by the image data.

4. The data creation apparatus according to claim 2,
wherein the image quality information is resolution information related to the resolution, and
the resolution information is resolution level information related to a resolution level of the subject in the image indicated by the image data.

5. The data creation apparatus according to claim 4,
wherein the setting condition is a condition including an upper limit and a lower limit of the resolution level of the subject.

6. The data creation apparatus according to claim 2,
wherein the image quality information is information related to the brightness of the subject or information related to the noise occurring at the position of the subject,
the information related to the brightness is a brightness value corresponding to the subject, and
the information related to the noise is an S/N value corresponding to the subject.

7. The data creation apparatus according to claim 6,
wherein the setting condition is a condition including an upper limit and a lower limit of the brightness value or an upper limit and a lower limit of the S/N value corresponding to the subject.

8. The data creation apparatus according to claim 1,
wherein the accessory information further includes a plurality of pieces of positional information assigned in association with the plurality of subjects, and
the positional information is information indicating a position of the subject in the image indicated by the image data.

9. The data creation apparatus according to claim 1, which is configured to further execute:
display processing of displaying an image indicated by the selection image data or a sample image having image quality satisfying the setting condition before executing the creation processing.

10. The data creation apparatus according to claim 9,
wherein two or more pieces of the selection image data are selected from the plurality of pieces of image data, and
in the display processing, an image of a part of the selection image data among the two or more pieces of the selection image data is displayed.

11. The data creation apparatus according to claim 10,
wherein in the display processing, images of the selected pieces of the selection image data are displayed based on a priority level set for each selection image data.

12. The data creation apparatus according to claim 1, which is configured to further execute:
determination processing of determining a purpose of the machine learning in accordance with designation from a user,
wherein in the setting processing, the setting condition corresponding to the purpose is set.

13. The data creation apparatus according to claim 1, which is configured to further execute:
determination processing of determining a purpose of the machine learning in accordance with designation from a user,
wherein in the setting processing, the setting condition corresponding to the purpose is suggested to the user before setting the setting condition.

14. The data creation apparatus according to claim 1, which is configured to further execute:
suggestion processing of suggesting an additional condition different from the setting condition to a user,
wherein the additional condition is a condition set with respect to the accessory information,
additional image data is selected under the additional condition from non-selection image data of which the identification information and the image quality information do not satisfy the setting condition, and
in a case where the additional image data is selected, the training data is created in the creation processing based on the selection image data and on the additional image data.

15. A storage device that stores the plurality of pieces of image data to be used for creating the training data via the data creation apparatus according to claim 1.

16. A data processing system comprising:
a data creation apparatus that creates training data from image data in which accessory information is recorded in an image in which a plurality of subjects are captured; and
a learning apparatus that performs machine learning using the training data, the data processing system being configured to execute:
setting processing of setting any setting condition related to identification information and to image quality information with respect to a plurality of pieces of image data in which the accessory information including a plurality of pieces of the identification information assigned in association with the plurality of subjects and a plurality of pieces of the image quality information assigned in association with the plurality of subjects is recorded;
creation processing of creating the training data based on selection image data in which the identification information and the image quality information satisfying the setting condition are recorded; and
learning processing of performing the machine learning using the training data.

17. A data creation method of creating training data used in machine learning from image data in which accessory information is recorded in an image in which a plurality of subjects are captured, the data creation method comprising:
a setting step of setting any setting condition related to identification information and to image quality information with respect to a plurality of pieces of image data in which the accessory information including a plurality of pieces of the identification information assigned in association with the plurality of subjects and a plurality of pieces of the image quality information assigned in association with the plurality of subjects is recorded; and
a creation step of creating the training data based on selection image data in which the identification information and the image quality information satisfying the setting condition are recorded.

18. A program causing a computer to function as the data creation apparatus according to claim 1, the program causing the computer to execute each of the setting processing and the creation processing.

19. An imaging apparatus that executes:
imaging processing of capturing an image in which a plurality of subjects are captured; and
generation processing of generating image data by recording accessory information in the image,
wherein the accessory information includes a plurality of pieces of identification information assigned in association with the plurality of subjects and a plurality of pieces of image quality information assigned in association with the plurality of subjects.

20. The imaging apparatus according to claim 19,
wherein the accessory information is information for selecting selection image data to be used for creating training data for machine learning.
